(19) United States
(12) Patent Application Publication
(10) Pub. No.: US 2022/0177383 A1
(43) Pub. Date: Jun. 9, 2022

(54) COMPOSTING MATERIALS AND METHODS OF PRODUCING THE SAME

(71) Applicant: Reciclaje y Compostaje Italo Cariola Sabaj SPA, Los Andes (CL)

(72) Inventor: Italo Cariola Sabaj, Los Andes (CL)

(21) Appl. No.: 17/457,714

(22) Filed: Dec. 6, 2021

Related U.S. Application Data
(60) Provisional application No. 63/122,335, filed on Dec. 7, 2020.

(51) Int. Cl. C05F 17/10; C05F 5/00; C05F 3/04; C05D 9/02; C05F 11/02; C05F 11/08; C05G 1/00

(52) U.S. Cl. CPC C05F 17/10; C05F 5/002; C05F 3/04; C05G 1/00; C05F 11/02; C05F 11/08; C05D 9/02

(57) ABSTRACT

In various embodiments, the present disclosure provides composting materials and methods of making the same.

### PRIORITY CLAIM

This application claims priority to U.S. Provisional Patent Application Ser. No. 63/122,335 filed Dec. 7, 2020, the entire contents of which are incorporated herein by reference.

### BACKGROUND

Aerobic composting is a process initiated by microbial succession, causing the degradation and stabilization of organic matter present in waste. In the past decade, aerobic composting has emerged as vital technology as it enables the recycling of organic waste and subsequent conversion into a useful, natural fertilizer.

### SUMMARY

In some aspects, the present disclosure provides a method of composting organic waste material, the method comprising: (a) forming a composting pile comprising a first layer including woodchips and a second layer including an organic fertilizer, wherein the second layer is formed on top of the first layer; (b) adding organic waste material on top of the second layer to form a composting pile; (c) mixing the composting pile to initiate a composting process; (d) adding organic waste material to the composting pile; and (e) maturing the organic waste material to obtain a compost, wherein the maturing step includes (1) a first thermophilic stage, (2) a second thermophilic stage, and (3) a mesophilic stage.

In some embodiments, the first thermophilic stage lasts about 3 to about 4 weeks during which time the composting pile is maintained at a temperature of about 65° C. to about 72° C. In some embodiments, the second thermophilic stage lasts for about 1 to about 2 months during which the composting pile is maintained at a temperature of about 55° C. to about 65° C. In some embodiments, the mesophilic stage lasts for a period of about 2 to about 6 months during which the composting pile is maintained at a temperature of about 10° C. to about 55° C.

In some embodiments, the method includes repeating the steps to obtain multiple batches of compost. In some embodiments, the multiple batches of compost are homogenous.

In some embodiments, a temperature of the composting pile is recorded daily during the first and second thermophilic stages. In some embodiments, a temperature of the composting pile is recorded once or twice a week during the mesophilic stage.

In some embodiments, the composting pile retains at least about 80% of moisture from the organic waste material.

In some embodiments, the first layer has a width of about 3.5 meters (m) and a height of about 0.3 m. In some embodiments, the second layer has a width of about 3 m and a height of about 0.15 m.

In some embodiments, the organic waste material is obtained from waste generated from an industrial process. In some embodiments, the industrial process is an agro-industrial process. In some embodiments, the industrial process is nut hulling. In some embodiments, the nut hulling process is a walnut hulling process.

In some embodiments, the organic fertilizer is selected from the group consisting of animal matter, animal excreta, human excreta, liquid manure, compost, sea algae, lime, and vegetable matter.

In some embodiments, a volume of the organic waste material is about 50% to about 60% less than the starting volume of organic waste material. In some embodiments, a weight of the organic waste material is about 40% to about 70% less than a starting weight of the organic waste material.

In some embodiments, the woodchips are obtained from shredding branches of a tree.

In some embodiments, about 1,500 cubic meters to about 1,800 cubic meters of compost is produced from about 1 hectare.

In some aspects, the present disclosure provides a composition comprising compost, wherein the composition comprises at least about 30%, by weight, organic matter of the total dry weight of the composition, wherein about 15% to about 30% of the organic matter is carbon (C) and about 1% to about 2% of the organic matter is nitrogen (N).

In some embodiments, the C to N ratio is about 18.2 to about 1. In some embodiments, the N is present as ammonium (NH₄⁺) and nitrate (NO₃⁻), wherein the NH₄⁺ to NO₃ ratio is about 1.3 to 1.

In some embodiments, the composition further comprises about 1% to about 2%, by weight, phosphorus (P) of the total dry weight of the composition. In some embodiments, the P is phosphorous pentoxide (P₂O₅).

In some embodiments, the composition further comprises about 2.5% to about 4.5%, by weight, potassium (K) of the total dry weight of the composition. In some embodiments, the K is potassium oxide (K₂O).

In some embodiments, the composition further comprises about 3.5% to about 5.5%, by weight, calcium (Ca) of the total dry weight of the composition. In some embodiments, the Ca is calcium oxide (CaO).

In some embodiments, the composition further comprises about 1% to about 2%, by weight, magnesium (Mg) of the total dry weight of the composition. In some embodiments, the Mg is magnesium oxide (MgO).

In some embodiments, the compost has a cation exchange capacity (CEC) of about 65 Meq/100 g. In some embodiments, the composition has a moisture content of about 25%, by weight, of the total weight material of the composition.

In some embodiments, the composition further comprises a micronutrient selected from the group consisting of zinc (Zn), iron (Fe), manganese (Mn), copper (Cu), and boron (B). In some embodiments, the composition further comprises one or more microorganisms selected from the group consisting of mesophilic bacteria, filamentous fungi, yeast, actinomycetes, phosphate solubilizing microbes, trichoderma spp., bacillus spp., pseudomonas ssp., azotobacter ssp., amylolytic bacteria, cellulitis, proteolytic bacteria, and mycorrhizae.

In some embodiments, the composition further comprises about 6% to about 10%, by weight, humic extract of the total dry weight of the composition. In some embodiments, the composition further comprises about 3% to about 5%, by weight, humic acid of the total dry weight of the composition. In some embodiments, the composition further comprises about 2% to about 4%, by weight, fulvic acid of the total dry weight of the composition.

### BRIEF DESCRIPTION OF THE DRAWINGS

FIG. 1 is a representative schematic showing an exemplary method of producing composting materials in accordance with embodiments of the present disclosure.

FIG. 2 is a representative schematic showing a cross-sectional view of the layers formed during the exemplary method of producing composting materials in FIG. 1 in accordance with embodiments of the present disclosure.

FIG. 3 is a representative image showing a process of forming the composting pile in accordance with embodiments of the present disclosure.

FIGS. 4A-4F are representative images showing incorporation of additional waste material into the composting pile during the active composting process in accordance with embodiments of the present disclosure.

### DETAILED DESCRIPTION

The present disclosure provides composting materials and methods of making the same.

The composting materials of the present disclosure exhibit desirable characteristics such as high organic matter, micronutrients, macronutrients, humic extracts, and microorganisms that impart increased functionality to the compost as compared to traditionally produced compost. Moreover, all or a portion of steps of the composting process described here can be repeated to obtain multiple batches of composting material having a high degree of homogeneity. The methods further optimize available resources by recycling organic waste matter generated through industrial process.

From the foregoing, it will be appreciated that specific embodiments of the invention have been described herein for purposes of illustration, but that various modifications may be made without deviating from the scope of the invention. Accordingly, the invention is not limited except as by the appended claims.

Headings are provided for convenience only and are not to be construed to limit the invention in any manner. Embodiments illustrated under any heading may be combined with embodiments illustrated under any other heading.

### Definitions

As used herein the following terms have the following meanings:

The term “about” when used before a numerical designation, e.g., temperature, time, amount, concentration, and such other, including a range, indicates approximations which may vary by (+) or (−) 10%, 5%, or 1%.

Also as used herein, “and/or” refers to and encompasses any and all possible combinations of one or more of the associated listed items, as well as the lack of combinations when interpreted in the alternative (“or”).

“Comprising” or “comprises” is intended to mean that the compositions, for example composting compositions, and methods include the recited elements, but do not exclude others. “Consisting essentially of,” when used to define compositions and methods, shall mean excluding other elements of any essential significance to the combination for the stated purpose. Thus, a composition consisting essentially of the elements as defined herein would not exclude other materials or steps that do not materially affect the basic and novel characteristic(s) of the claimed invention. “Consisting of” shall mean excluding more than trace elements of other ingredients and substantial method steps. Embodiments defined by each of these transition terms are within the scope of this invention.

“Thermophilic” refers to the reaction favoring the survival, growth, and/or activity of thermophilic microorganisms. Thermophilic microorganisms are “heat loving,” with a growth range between 45° C. and 80° C.

“Mesophilic” refers to the reaction favoring the survival, growth, and/or activity of mesophilic microorganisms. Mesophilic microorganisms grow best in moderate temperatures, with an optimum growth range from 20° C. to 45° C.

### Composting Material

Aspects of the present disclosure are directed to composting materials. As used herein the term “composting materials” is used interchangeably with the term “compost.”

In some embodiments, the composting material has a high macronutrient content. Non-limiting examples of macronutrients include nitrogen (N), phosphorus (P), potassium (K), calcium (Ca), magnesium (Mg), and sulfur (S). In some embodiments, the composting material comprises about 1% to about 20%, by weight, of the total dry weight of the composting material, macronutrients. For example, about 1% to about 4%, about 1% to about 6%, about 1% to about 8%, about 1% to about 10%, about 1% to about 12%, about 1% to about 14%, about 3% to about 6%, about 3% to about 8%, about 3% to about 10%, about 3% to about 12%, about 3% to about 14%, about 5% to about 10%, about 5% to about 15%, about 2% to about 6%, about 5% to about 12%, about 5% to about 20%, about 10% to about 20%, about 15% to about 20%, by weight, of the total dry weight of the composting material, macronutrients.

In some embodiments, the N is in the form of ammonium (NH₄⁺) and nitrate (NO₃⁻). N is initially added to the compost in the form of organic N; however, over time microorganisms in the compost convert the N to NH₄⁺:NO₃⁻, which can then be readily used by plants for production proteins, nucleic acids, amino acids, enzymes, and co-enzymes necessary for cell growth and function. In some embodiments, the NH₄⁺:NO₃⁻ ratio is about 1:1, about 1.1:1, about 1.2:1, about 1.3:1, about 1.4:1, about 1.5:1, about 1.6:1, about 1.8:1, or about 2:1.

In some embodiments, composting material comprises about 0.5% to about 2.5%, by weight, of the total dry weight of the composting material, P. For example, about 1.2% to about 2%, about 1.4% to about 2%, about 1.6% to about 2%, about 1.8% to about 2%, about 1% to about 1.8%, about 1% to about 1.6%, about 1% to about 1.4%, or about 1% to about 1.2%, by weight, of the total dry weight of the composting material, P. In some embodiments, the P is in the form of phosphorus pentoxide (P₂O₅). In some embodiments, composting material comprises about 0.5% to about 2.5%, by weight, of the total dry weight of the composting material, P₂O₅. For example, about 1.2% to about 2%, about 1.4% to about 2%, about 1.6% to about 2%, about 1.8% to about 2%, about 1% to about 1.8%, about 1% to about 1.6%, about 1% to about 1.4%, or about 1% to about 1.2%, by weight, of the total dry weight of the composting material, P₂O₅.

In some embodiments, the composting material comprises about 2% to about 5%, by weight, of the total dry weight of the composting material, K. For example, about 2.5% to about 4.5%, about 2% to about 4%, about 2.5% to about 4%, about 2.5% to about 3.5%, about 2.5% to about 3%, or about 2% to about 3%, by weight, of the total dry weight of the composting material, K. In some embodiments, the K is in the form of potassium oxide (K₂O). In some embodiments, the composting material comprises about 2% to about 5%, by weight, of the total dry weight of the composting material, K₂O. For example, about 2.5% to about 4.5%, about 2% to about 4%, about 2.5% to about 4%, about 2.5% to about 3.5%, about 2.5% to about 3%, or about 2% to about 3%, by weight, of the total dry weight of the composting material, K₂O.

In some embodiments, the composting material comprises about 3% to about 6%, by weight, of the total dry weight of the composting material, Ca. For example, about 3% to about 4%, about 3.5% to about 5.5%, about 4% to about 6%, about 3% to about 5.5%, about 3% to about 4.5%, about 4% to about 5%, about 1% to about 1.4%, or about 1% to about 1.2%, by weight, of the total dry weight of the composting material, Ca. In some embodiments, the Ca is in the form of calcium oxide (CaO). In some embodiments, composting material comprises about 3% to about 6%, by weight, of the total dry weight of the composting material, CaO. For example, about 3% to about 4%, about 3.5% to about 5.5%, about 4% to about 6%, about 3% to about 5.5%, about 3% to about 4.5%, about 4% to about 5%, about 1% to about 1.4%, or about 1% to about 1.2%, by weight, of the total dry weight of the composting material, CaO.

In some embodiments, composting material comprises about 0.5% to about 2.5%, by weight, of the total dry weight of the composting material, Mg. For example, about 1.2% to about 2%, about 1.4% to about 2%, about 1.6% to about 2%, about 1.8% to about 2%, about 1% to about 1.8%, about 1% to about 1.6%, about 1% to about 1.4%, or about 1% to about 1.2%, by weight, of the total dry weight of the composting material, Mg. In some embodiments, the Mg is in the form of magnesium oxide (MgO). In some embodiments, composting material comprises about 0.5% to about 2.5%, by weight, of the total dry weight of the composting material, MgO. For example, about 1.2% to about 2%, about 1.4% to about 2%, about 1.6% to about 2%, about 1.8% to about 2%, about 1% to about 1.8%, about 1% to about 1.6%, about 1% to about 1.4%, or about 1% to about 1.2%, by weight, of the total dry weight of the composting material, MgO.

In some embodiments, composting material comprises about 0.5% to about 2.5%, by weight, of the total dry weight of the composting material, S. For example, about 1.2% to about 2%, about 1.4% to about 2%, about 1.6% to about 2%, about 1.8% to about 2%, about 1% to about 1.8%, about 1% to about 1.6%, about 1% to about 1.4%, or about 1% to about 1.2%, by weight, of the total dry weight of the composting material, S. In some embodiments, the S is in the form of ammonium sulphate ((NH₄)₂SO₄), potassium sulfate (K₂SO₄), and/or magnesium sulfate (MgSO₄). For example, about 1.2% to about 2%, about 1.4% to about 2%, about 1.6% to about 2%, about 1.8% to about 2%, about 1% to about 1.8%, about 1% to about 1.6%, about 1% to about 1.4%, or about 1% to about 1.2%, by weight, of the total dry weight of the composting material, (NH₄)₂SO₄, K₂SO₄, and/or MgSO₄.

In some embodiments, the composting material has a high micronutrient content. Composting materials can provide essential micronutrients that are not found in mineral fertilizers. Non-limiting examples of micronutrients include zinc (Zn), iron (Fe), manganese (Mn), copper (Cu), and boron (B). In some embodiments, the composting material comprises about 1% to about 20%, by weight, of the total dry weight of the composting material, micronutrients. For example, about 1% to about 4%, about 1% to about 6%, about 1% to about 8%, about 1% to about 10%, about 1% to about 12%, about 1% to about 14%, about 3% to about 6%, about 3% to about 8%, about 3% to about 10%, about 3% to about 12%, about 3% to about 14%, about 5% to about 10%, about 5% to about 15%, about 2% to about 6%, about 5% to about 12%, about 5% to about 20%, about 10% to about 20%, about 15% to about 20%, by weight, of the total dry weight of the composting material, micronutrients.

In some embodiments, the composting material has a high organic matter content. Organic matter refers to carbon-based compounds found within the composting material. High organic matter content allows for a greater retention of essential nutrients (e.g. macronutrients and micronutrients), water holding capacity, and cation exchange capacity (CEC). In some embodiments, the composting material comprises between about 10% to about 50%, by weight, of the total dry weight of the composting material, organic matter. For example, the composting material comprises about 10% to about 15%, about 10% to about 20%, about 10% to about 25%, about 10% to about 30%, about 10% to about 35%, about 10% to about 40%, about 10% to about 45%, about 15% to about 20%, about 15% to about 25%, about 15% to about 30%, about 15% to about 40%, about 15% to about 45%, about 15% to about 50%, about 20% to about 25%, about 20% to about 30%, about 20% to about 35%, about 20% to about 40%, about 20% to about 45%, about 20% to about 50%, about 25% to about 30%, about 25% to about 35%, about 25% to about 40%, about 25% to about 45%, about 25% to about 50%, about 30% to about 35%, about 30% to about 40%, about 30% to about 45%, about 30% to about 50%, about 35% to about 40%, about 35% to about 45%, about 35% to about 50%, about 40% to about 45%, about 40% to about 50%, or about 45% to about 50%, by weight, of the total dry weight of the composting material, organic matter.

In some embodiments, the composting material has a high organic matter content, where about 10% to about 40%, by weight, of the total dry weight of organic matter is C. For example, about 15% to about 30%, about 10% to about 20%, about 15% to about 40%, about 10% to about 35%, about 15% to about 35%, about 10% to about 30%, about 10% to about 25%, by weight, of the total dry weight of the organic matter is C. In some embodiments, the composting material comprises about 30%, by weight, of the total dry weight of the composting material, organic matter, where about 15% to about 30%, by weight of the organic matter, is C.

In some embodiments, the composting material has a high organic matter content, wherein about 0.5% to 3%, by weight, of the total dry weight of the organic matter is N. For example, about 1% to about 2%, about 1.5% to about 2.5%, about 2% to about 3%, about 2.5% to about 3%, about 1% to about 3%, about 1% to about 2.5%, about 1.5% to about 5%, by weight, of the total dry weight of the organic matter is N. In some embodiments, the composting material comprises about 30%, by weight, of the total dry weight of the composting matter, organic matter, where about 1% to about 2%, by weight of the organic matter, is N.

In some embodiments, the composting material has a high humic extract content. Humic extract comprises both humic acid and fulvic acid present in soils. The humic extract is considered to be the most active part of organic matter and is formed by the decomposition and oxidation of organic matter. In some embodiments, the composting material comprises about 3% to about 15%, by weight, of the total dry weight of the composting material, humic extract. For example, about 3% to about 10%, about 4% to about 10%, about 5% to about 10%, about 6% to about 10%, about 7% to about 10%, about 8% to about 10%, about 5% to about 15%, about 6% to about 15%, about 7% to about 15%, about 8% to about 15%, about 9% to about 15%, and about 10% to about 15%. In some embodiments, the composting material comprises about 1% to about 8%, by weight, of the total dry weight of the composting material and/or total weight of the humic extract, humic acid. For example, about 3% to about 5%, about 2% to about 6%, about 3% to about 8%, about 4% to about 6%, about 4% to about 5%, about 2% to about 5%, by weight, of the total dry weight of the composting material and/or total weight of the humic extract, humic acid. In some embodiments, the composting material comprises about 1% to about 8%, by weight, of the total dry weight of the composting material and/or total weight of the humic extract, fluvic acid. For example, about 3% to about 5%, about 2% to about 6%, about 2% to about 4%, about 3% to about 4%, about 1% to about 5%, about 3% to about 8%, about 4% to about 6%, about 4% to about 5%, about 2% to about 5%, by weight, of the total dry weight of the composting material and/or total weight of the humic extract, fluvic acid.

In some embodiments, the composting material has a high microorganism content. Increased microorganism activity and diversity in the composting material improves nutrient cycling and can promote disease suppression. In some embodiments, the composting material comprises one or more of the following microorganisms: mesophilic bacteria, filamentous fungi, yeast, actinomycetes, phosphate solubilizing microbes, trichoderma spp., bacillus spp., pseudomonas ssp., azotobacter ssp., amylolytic bacteria, cellulitis, and proteolytic bacteria. In some embodiments, the composting material further comprises mycorrhizae (e.g., endomycorrhizae and/or ectomycorrhizae).

In some embodiments, the composting material comprises mesophilic bacteria. In some embodiments, the composting material comprises mesophilic bacteria at a concentration of about 1×10⁷ colony-forming units per gram (CFU/g) to about 9×10⁹ CFU/g. For example, 1×10⁸ CFU/g to about 10×10⁹ CFU/g, 1×10⁷ CFU/g to about 9×10⁸ CFU/g, 1×10⁸ CFU/g to about 9×10⁸ CFU/g, about 5×10⁷ CFU/g to about 8×10⁸ CFU/g, about 1×10⁷ CFU/g to about 9×10⁸ CFU/g, 6×10⁷ CFU/g to about 8×10⁸ CFU/g, 1×10⁸ CFU/g to about 9×10⁸ CFU/g, about 6×10⁸ CFU/g to about 8×10⁹ CFU/g.

In some embodiments, the composting material comprises filamentous fungi. In some embodiments, the composting material comprises filamentous fungi at a concentration of about 2×10² CFU/g to about 9×10³ CFU/g. For example, 4×10² CFU/g to about 4.4×10³ CFU/g, 3×10² CFU/g to about 6×10³ CFU/g, 2×10³ CFU/g to about 4×10³ CFU/g, about 3×10² CFU/g to about 8×10² CFU/g, about 5×10² CFU/g to about 9×10³ CFU/g, 2×10² CFU/g to about 8×10² CFU/g, 7×10² CFU/g to about 4×10³ CFU/g, about 4×10² CFU/g to about 9×10³ CFU/g.

In some embodiments, the composting material comprises yeast. In some embodiments, the composting material comprises yeast at a concentration of about 1×10⁴ CFU/g to about 5×10⁴ CFU/g. For example, 4×10⁴ CFU/g to about 4.4×10⁴ CFU/g, 3×10⁴ CFU/g to about 5×10⁴ CFU/g, 2×10⁴ CFU/g to about 4×10⁴ CFU/g, about 1×10⁴ CFU/g to about 5×10⁴ CFU/g, about 1.1×10⁴ CFU/g to about 2×10⁴ CFU/g, 3.5×10⁴ CFU/g to about 5×10⁴ CFU/g, 4×10⁴ CFU/g to about 4.3×10⁴ CFU/g, about 1.1×10⁴ CFU/g to about 4.3×10⁴ CFU/g.

In some embodiments, the composting material comprises actinomycetes. In some embodiments, the composting material comprises about 1 CFU/g to about 10 CFU/g of actinomycetes. For example, about 8 CFU/g to about 10 CFU/g, about 6 CFU/g to about 10 CFU/g, about 4 CFU/g to about 10 CFU/g, about 2 CFU/g to about 10 CFU/g, about 1 CFU/g to about 8 CFU/g, about 1 CFU/g, about 1 CFU/g to about 6 CFU/g, about 1 CFU/g to about 4 CFU/g, or about 1 CFU/g to about 2 CFU/g.

In some embodiments, the composting material comprises phosphate solubilizing microbes. In some embodiments, the composting material comprises about 1 CFU/g to about 10 CFU/g of phosphate solubilizing microbes. For example, about 8 CFU/g to about 10 CFU/g, about 6 CFU/g to about 10 CFU/g, about 4 CFU/g to about 10 CFU/g, about 2 CFU/g to about 10 CFU/g, about 1 CFU/g to about 8 CFU/g, about 1 CFU/g, about 1 CFU/g to about 6 CFU/g, about 1 CFU/g to about 4 CFU/g, or about 1 CFU/g to about 2 CFU/g.

In some embodiments, the composting material comprises trichoderma spp. In some embodiments, the composting material comprises about 1 CFU/g to about 10 CFU/g of trichoderma spp. For example, about 8 CFU/g to about 10 CFU/g, about 6 CFU/g to about 10 CFU/g, about 4 CFU/g to about 10 CFU/g, about 2 CFU/g to about 10 CFU/g, about 1 CFU/g to about 8 CFU/g, about 1 CFU/g, about 1 CFU/g to about 6 CFU/g, about 1 CFU/g to about 4 CFU/g, or about 1 CFU/g to about 2 CFU/g.

In some embodiments, the composting material comprises bacillus spp. In some embodiments, the composting material comprises about 1×10⁸ CFU/g to about 1×10⁹ CFU/g bacillus spp. For example, about 1×10⁸ CFU/g to about 5×10⁸ CFU/g, 6×10⁸ CFU/g to about 8×10⁸ CFU/g, 5×10⁸ CFU/g to about 5.5×10⁸ CFU/g, 4×10⁸ CFU/g to about 6×10⁸ CFU/g, 3×10⁸ CFU/g to about 5.5×10⁸ CFU/g, or 6×10⁸ CFU/g to about 9×10⁸ CFU/g.

In some embodiments, the composting material comprises pseudomonas ssp. In some embodiments, the composting material comprises about 1×10⁴ CFU/g to about 1×10⁵ CFU/g pseudomonas spp. For example, about 1×10⁴ CFU/g to about 5×10⁴ CFU/g, 2×10⁴ CFU/g to about 4×10⁴ CFU/g, 1×10⁴ CFU/g to about 1.5×10⁴ CFU/g, 2×10⁴ CFU/g to about 5×10⁵ CFU/g, 3×10⁴ CFU/g to about 5.5×10⁴ CFU/g, or 1×10⁴ CFU/g to about 6×10⁴ CFU/g.

In some embodiments, the composting material comprises azotobacter ssp. In some embodiments, the composting material comprises about 1 CFU/g to about 10 CFU/g of azotobacter ssp. For example, about 8 CFU/g to about 10 CFU/g, about 6 CFU/g to about 10 CFU/g, about 4 CFU/g to about 10 CFU/g, about 2 CFU/g to about 10 CFU/g, about 1 CFU/g to about 8 CFU/g, about 1 CFU/g, about 1 CFU/g to about 6 CFU/g, about 1 CFU/g to about 4 CFU/g, or about 1 CFU/g to about 2 CFU/g.

In some embodiments, the composting material comprises amylolytic bacteria. In some embodiments, the composting material comprises about 1×10⁵ CFU/g to about 9×10⁵ CFU/g amylolytic bacteria. For example, about 2.3×10⁵ CFU/g to about 5×10⁵ CFU/g, 2×10⁵ CFU/g to about 4×10⁵ CFU/g, 1×10⁵ CFU/g to about 1.5×10⁵ CFU/g, 2×10⁵ CFU/g to about 5×10⁵ CFU/g, 3×10⁵ CFU/g to about 5.5×10⁵ CFU/g, or 1×10⁵ CFU/g to about 6×10⁵ CFU/g.

In some embodiments, the composting material comprises cellulitis. In some embodiments, the composting material comprises about 1×10² CFU/g to about 9×10² CFU/g cellulitis. For example, about 2.3×10² CFU/g to about 5×10² CFU/g, 2×10² CFU/g to about 4×10² CFU/g, 1×10² CFU/g to about 1.5×10² CFU/g, 2×10² CFU/g to about 5×10² CFU/g, 3×10² CFU/g to about 5.5×10² CFU/g, or 1×10² CFU/g to about 6×10² CFU/g.

In some embodiments, the composting material comprises proteolytic bacteria. In some embodiments, the composting material comprises about 1×10⁵ CFU/g to about 9×10⁵ CFU/g proteolytic bacteria. For example, about 2.3×10⁵ CFU/g to about 5×10⁵ CFU/g, 2×10⁵ CFU/g to about 4×10⁵ CFU/g, 1×10⁵ CFU/g to about 1.5×10⁵ CFU/g, 2×10⁵ CFU/g to about 5×10⁵ CFU/g, 3×10⁵ CFU/g to about 5.5×10⁵ CFU/g, or 1×10⁵ CFU/g to about 6×10⁵ CFU/g.

In some embodiments, the composition has a high carbon (C) to nitrogen (N) ratio. In some embodiments, the C to N ratio (C:N) is between about 10:1 to about 30:1. For example, about 10:1, about 11:1, about 12:1, about 13:1, about 14:1, about 15:1, about 16:1, about 17:1, about 18:1, about 19:1, about 20:1, about 21:1, about 22:1, about 23:1, about 24:1, about 25:1, about 26:1, about 27:1, about 28:1, about 29:1, or about 30:1.

In some embodiments, the composting material has a high moisture content. In some embodiments, the composting material has a moisture content between about 10% to about 80%. For example, about 10% to about 15%, about 15% to about 30%, about 30% to about 40%, about 15% to about 20%, about 15% to about 35%, about 15% to about 40%, about 20% to about 25%, about 20% to about 30%, about 20% to about 40%, about 25% to about 30%, about 25% to about 35%, about 25% to about 40%, about 10% to about 25%, about 10% to about 20%, about 15% to about 25%, about 10% to about 60%, about 60% to about 70%, about 30% to about 70%, about 20% to about 70%, about 40% to about 70%, about 50% to about 70%, about 15% to about 45%, about 15% to about 55%, about 15% to about 65%, or about 15% to about 70%.

In some embodiments, the composting material comprises reduced amounts of toxic heavy metals. Toxic heavy metals are a significant concern for the environment and as such, composting materials should have a safe amount of heavy metals so as to reduce the environmental impact. Non-limiting examples of toxic heavy metals include arsenic (As), cadmium (Cd), chromium (Cr), mercury (Hg), nickel (Ni), and lead (Pb). In some embodiments, the composting materials comprise less than about 5%, less than about 4%, less than about 3%, less than about 2.5%, less than about 2%, less than about 1.5%, less than about 1%, less than about 0.5%, or less than about 0.1%, by weight, of the total dry weight of the composting material heavy metals. In some embodiments, the composting materials comprise a concentration of less than about 0.01 parts per million (ppm), less than about 0.05 ppm, less than about 0.1 ppm, less than about 0.2 ppm, less than about 0.3 ppm, less than about 0.4 ppm, less than about 0.5 ppm, less than about 0.6 ppm, less than about 0.7 ppm, less than about 0.8 ppm, less than about 0.9 ppm, less than about 1 ppm, less than about 1.5 ppm, less than about 2 ppm, less than about 2.5 ppm, less than about 3 ppm, less than about 3.5 ppm, less than about 4 ppm, less than about 4.5 ppm, less than about 5 ppm, less than about 5.5 ppm, less than about 6 ppm, less than about 6.5 ppm, less than about 7 ppm, less than about 7.5 ppm, less than about 8 ppm, less than about 8.5 ppm, less than about 9 ppm, less than about 9.5 ppm, less than about 10 ppm, less than about 11 ppm, less than about 12 ppm, less than about 13 ppm, less than about 14 ppm, less than about 15 ppm, less than about 16 ppm, less than about 17 ppm, less than about 18 ppm, less than about 19 ppm, less than about 20 ppm, less than about 25 ppm, less than about 30 ppm, less than about 35 ppm, less than about 40 ppm, less than about 45 ppm, less than about 50 ppm, less than about 60 ppm, less than about 70 ppm, less than about 80 ppm, less than about 90 ppm, less than about 100 ppm, less than about 200 ppm, or less than about 300 ppm of heavy metals.

In some embodiments, the composting material has a high CEC. The CEC is a metric denoting the total cation exchange capacity of the composting material and influences composting material's ability to retain essential nutrients (e.g., macronutrients and micronutrients), which can lead to improved fertilizer use efficiency. The more organic matter that is present in the composting material, the higher the CEC. In some embodiments, the composting material has a CEC of about 50 meq/100 g to about 70 meq/100 g. For example, about 50 meq/100 g, about 55 meq/100 g, about 60 meq/100 g, about 65 meq/100 g, or about 70 meq/100 g.

In some embodiments, the composting material comprises at least about 30%, by weight, organic matter of the total dry weight of the composting material, wherein about 15% to about 30% of the organic matter is carbon (C) and about 1% to about 2% of the organic matter is nitrogen (N). In some embodiments, the C to N ratio is about 18.2 to about 1.

### Methods of Making Composting Material

Aspects of the present disclosure are directed to methods of making composting material.

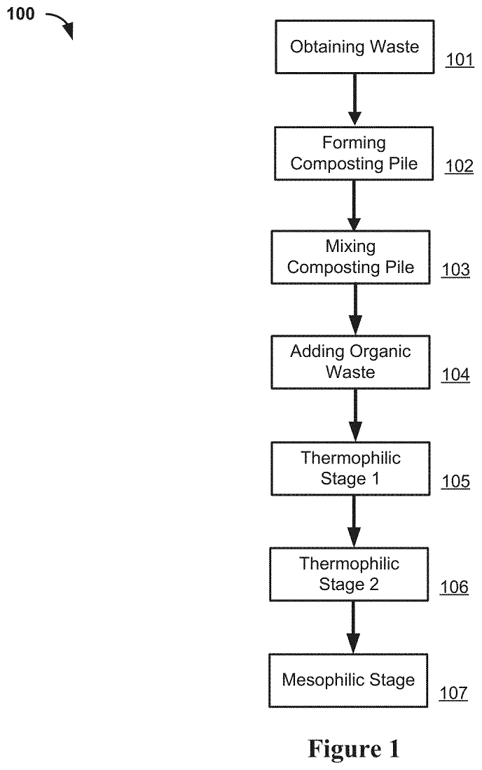

FIG. 1 is a representative schematic of a method 100 of producing composting material in accordance with embodiments of the present disclosure. At step 101, the method 100 begins by obtaining organic waste. In some embodiments, the organic waste is obtained from industrial processes. In some embodiments, the industrial processes are agro-industrial processes. Obtaining waste from industrial processes can minimize the environmental impact of said processes by utilizing the generated waste to produce composting material. In some embodiments, the industrial waste is obtained from the production of fibers and textiles (e.g., bleach and dyeing), animal feeds (e.g., feeds for livestock, poultry, aquaculture and pets), canneries (e.g., vegetables and fruits), production of food and beverages (e.g., beer, bread, meat packing, and/or milk products), production of pulp and paper, and nut hulling (e.g., walnuts, almonds, and coconuts). In some embodiments, the organic waste is obtained from one or more of walnut shells, mushroom soil, manure, and roe. In yet another embodiment, the organic waste is obtained from disposable food times (e.g., disposable forks, knifes, food packaging, cups, straws, bags, etc.).

In some embodiments, the organic waste has a high organic matter content. When the organic waste has a low organic content, it is relatively easy to obtain composting materials having a near ideal amount of organic matter content (e.g., 55% to 70%). However, in some embodiments, the present disclosure uses organic waste material having a high organic matter content (e.g., 50%), wherein after the compost is formed, the resulting compost product has a lower organic matter content (e.g., 40%). The reduction in organic matter content from the starting material to the final composting product is due to the mineralization of the organic matter into nutrients that are then available for plant growth. As a result, the final composting product has superior characteristics (e.g., increased nutrients) when formed from organic waste material having a high organic matter content as compared to organic waste material having a low organic matter content. In some embodiments, the organic waste has a high organic matter content of about 50% to about 100%, by weight, of the total dry weight of the organic waste. For example, the organic waste has a high organic matter content of about 50%, about 55%, about 60%, about 65%, about 70%, about 75%, about 80%, about 85%, about 90%, about 95%, or about 100%, by weight, of the total dry weight of the organic waste.

In some embodiments, the organic waste material comprises walnut shells, wherein the organic matter content is about 84%, by weight, of the total dry weight of the organic waste material. In some embodiments, the organic waste material comprises mushroom soil, wherein the organic matter content is about 64%, by weight, of the total dry weight of the organic waste material. In some embodiments, the organic waste material comprises manure, wherein the organic matter content is about 57%, by weight, of the total dry weight of the organic waste material.

In some embodiments, the organic waste is obtained from nut hulling processes. In some embodiments, the nut hulling process is one or more of almond, cashew, brazilnut, chestnut, coconut, hazelnut, macadamia nut, peanut, pecan, pistachio and walnut hulling. In some embodiments, the nut hulling process comprises removing the pericarp (outer hull of the nut) and the fleshy mesocarp. In some embodiments, the process comprises rupturing the pericarp of the nut and then removing the pericarp.

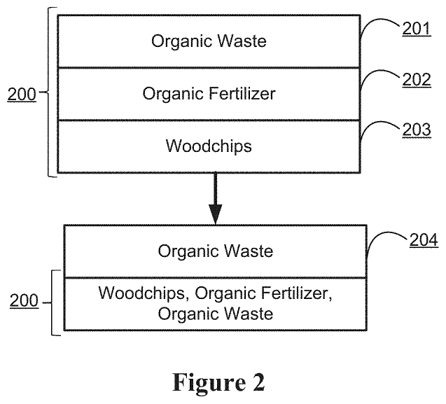

The method 100 can continue in step 102 including the formation of a composting pile. As used herein the term “pile” is used interchangeably with the term “windrow.” In some embodiments, the composting pile comprises a first layer including woodchips and a second layer including an organic fertilizer, wherein the second layer is formed on top of the first layer and adding the organic waste material on top of the second layer. FIG. 2 is a schematic depicting a composting pile 200 comprising three layers: woodchip layer 203, organic fertilizer layer 202, and organic waste layer 201. As shown in FIG. 2, the composting pile 200 comprises layer 203 including woodchips and a layer 202 including organic fertilizer layer 202, where the organic fertilizer layer 202 is on top of the woodchip layer 203. The composting pile 200 then comprises a layer 201 including organic waste layer 201, where the organic waste layer 201 is formed on top of the organic fertilizer layer 202.

In some embodiments, the woodchips include any pieces of wood formed by cutting or chipping larger pieces of wood such as trees, branches, logging residues, stumps, roots, and wood waste. Non-limiting examples of suitable woodchip sources include sawdust, wood branch trimmings, wood fibers, and/or mulch. In some embodiments, the woodchips are obtained from shredding branches of trees.

In some embodiments, the organic fertilizer is animal matter, animal excreta (e.g., manure), human excreta, compost, liquid manure, sea algae, lime, and vegetable matter (e.g., compost and crop residues). In some embodiments, the organic fertilizer is naturally occurring and includes one or more of animal wastes from meat processing, peat, manure, slurry, and guano.

The method 100 can continue in step 103 including mixing the composting pile to initiate the composting process. Step 103 can further include introducing water to the composting pile wile mixing the composting pile. Mixing, and if necessary, with the introduction of water, initiates the composting process by introducing oxygen (O₂) into the composting pile. Introduction of O₂ (e.g., aeration) provides the composting microbes with the O₂ necessary to convert the organic matter into compost and to achieve the temperatures necessary for the more rapid decomposition of the organic matter. While decomposition can occur without mixing and aeration of the pile, the mixing step helps to increase the overall rate of decomposition. The mixing further enables the release of greenhouse gases produced during the composting process such as carbon dioxide (CO₂). In some embodiments, the composting pile is mixed by a windrow turning. This type of composting involves forming the composting pile into rows of long piles called “windrows” and aerating them periodically by either manually or mechanically turning the piles.

In some embodiments, the composting pile is a windrow. The size of the windrow depends on the equipment capacity of the turner equipment. In some embodiments, the width of the woodchip layer 203 is about 2 meters (m), about 2.5 m, about 3 m, about 3.5 m, about 4 m, about 4.5 m, about 5 m, about 5.5 m, about 6 m, about 6.5 m, about 7 m, about 7.5 m, about 8 m, about 8.5 m, about 9 m, about 9.5 m, or about 10 m. In some embodiments, the thickness of the woodchip layer 203 is about 0.1 m, about 0.2 m, about 0.3 m, about 0.4 m, about 0.5 m, about 0.6 m, about 0.7 m, about 0.8 m, about 0.9 m, or about 1 m. In some embodiments, the woodchip layer 203 has a width of about 3.5 m and a thickness of about 0.3 m. In some embodiments, the width of the organic fertilizer layer 202 is about 1 m, about 1.5 m, about 2 m, about 2.5 m, about 3 m, about 3.5 m, about 4 m, about 4.5 m, about 5 m, about 5.5 m, about 6 m, about 6.5 m, about 7 m, about 7.5 m, about 8 m, about 8.5 m, or about 9 m. In some embodiments, the thickness of the organic fertilizer layer 202 is about 0.1 m, about 0.15 m, about 0.2 m, about 0.25 m, about 3 m, about 0.35 m, about 0.4 m, about 0.45 m, about 0.5 m, about 0.55 m, about 0.6 m, about 0.65 m, about 0.7 m, about 0.75 m, about 0.8 m, about 0.85 m, about 0.9 m, about 0.95, or about 1 m. In some embodiments, the organic fertilizer layer 202 has a width of about 3 m and a thickness of about 0.15 m. In some embodiments, the woodchip layer 203 has a width of about 3.5 m and a thickness of about 0.3 m and the organic fertilizer layer 202 has a width of about 3 m and a thickness of about 0.15 m.

The method 100 can continue in an optional step 104 including adding additional organic waste to the composting pile comprising the mixed woodchips, organic fertilizer, and the first addition of organic waste. FIG. 2 is a schematic depicting a layer 204 comprising additional organic waste, where the additional organic waste layer 204 is added on top of the composting pile 200 including the mixed woodchips, organic fertilizer, and organic waste.

In some embodiments, after the addition of the second organic waste layer, the composting pile 200 is mixed. In some embodiments, the methods comprise multiple rounds of introducing additional organic waste to the composting pile throughout the composting process. For example, in some embodiments, additional organic waste can be added 1 time, 2 times, 3 times, 4 times, 5 times, 6 times, 7 times, 8 times, 9 times, 10 times, or more during the composting process.

In some embodiments, the methods comprising incorporating additional organic waste into the composting pile during the active composting stage is accomplished in an easy and efficient manner. The methods include using a backhoe to rapidly “open” the pile during the active composting stage. The backhoe can displace the material at the top of the composting pile, creating an “opening” (e.g., a hole and/or groove) along the composting pile in which additional waste material can be added. This process allows for a fast and easy way to “open” or prepare the windrow for adding additional waste material. For example, for a windrow of 460 ft length, the process to open the windrow and add additional waste material takes only about 5 to about 10 minutes. In some embodiments, the multiple rounds of introducing additional waste to the composting pile during the active composting can produce a high yield of composting material. The high yield of the compost per unit area demonstrates the utility of the disclosed methods in optimizing available resources (e.g., space) to produce large amounts of compost. In some embodiments, the methods yield 1,000 to 3,000 cubic meters (m³) per hectare of compost. For example, about 1,000 m³ per hectare, about 1,200 m³ per hectare, about 1,400 m³ per hectare, about 1,500 m³ per hectare, about 1,600 m³ per hectare, about 1,800 m³ per hectare, about 2,000 m³ per, about 2,200 m³ per hectare, about 2,400 m³ per hectare, about 2,500 m³ per hectare, about 2,600 m³ per hectare, about 2,800 m³ per hectare, or about 3,000 m³ per hectare of compost.

The method 100 can continue in step 105 including a first thermophilic stage. During the thermophilic stage, heat-loving bacteria such as actinomycetes and fungi proliferate and assist in breaking down the organic matter into compost and, in particular, proteins, fats, and complex polymers. The higher temperatures during the thermophilic stage destroy and/or make go dormant heat-intolerant organisms to include human and plant pathogens. In some embodiments, during first thermophilic stage, the composting pile is maintained at a temperature of about 65° C. to about 72° C. For example, about 65° C., about 66° C., about 67° C., about 68° C., about 69° C., about 70° C., about 71° C., or about 72° C. In some embodiments, the first thermophilic stage lasts from about 3 weeks to about 4 weeks. For example, about 3 weeks, about 3.1 weeks, about 3.2 weeks, about 3.3 weeks, about 3.4 weeks, about 3.5 weeks, about 3.6 weeks, about 3.7 weeks, about 3.8 weeks, about 3.9 weeks, or about 4 weeks. In some embodiments, the composting pile is maintained at a temperature of about 65° C. to about 72° C. for about 3 weeks to about 4 weeks.

In some embodiments, the composting pile is maintained at a temperature of about 65° C. to about 72° C. by monitoring and aerating (e.g., turning) the composting pile. During the thermophilic stage, O₂ is rapidly depleted by thermophilic organisms and the temperature of the composting pile, in turn, increases. To prevent the temperature of the composting pile from increasing beyond 72° C., the composting pile is turned and/or aerated, dissipating heat in the process. In some embodiments, water can be added to the composting pile to assist in cooling down (e.g., reducing the temperature) of the composting pile. In some embodiments, the temperature of the composting pile is monitored at least once a day throughout the first thermophilic stage so as to ensure that the temperature range remains between about 65° C. to about 72° C.

The method 100 can continue in step 106 including a second thermophilic stage. While the second thermophilic phase provides the same benefits as the first thermophilic stage (e.g., breakdown of organic matter by heat-loving organisms), the second thermophilic phase also enables complete composting of the composting pile and thus prevents the additional step of screening and/or crushing large particles in the final compost product. In some embodiments, during the second thermophilic stage, the composting pile is maintained at a temperature of about 55° C. to about 65° C. For example, about 55° C., about 56° C., about 57° C., about 58° C., about 59° C., about 60° C., about 61° C., about 62° C., about 63° C., about 64° C., or about 65° C. In some embodiments, the second thermophilic stage lasts from about 1 month to about 2 months. For example, about 1 month, about 1.1 months, about 1.2 months, about 1.3 months, about 1.4 months, about 1.5 months, about 1.6 months, about 1.7 months, about 1.8 months, about 1.9 months, or about 2 months. In some embodiments, the composting pile is maintained at a temperature of about 55° C. to about 65° C. for about 1 month to about 2 months.

In some embodiments, the composting pile is maintained at a temperature of about 55° C. to about 65° C. by monitoring and aerating (e.g., turning) the composting pile. In order to prevent the temperature of the composting pile from increasing beyond 65° C., the composting pile is turned and/or aerated, dissipating heat in the process. In some embodiments, the temperature of the composting pile is monitored throughout the second thermophilic stage so as to ensure that the temperature range remains between about 55° C. to about 65° C.

In some embodiments, during the first and second thermophilic stage certain bacteria, fungi, and actinomycetes predominate. In some embodiments, the bacteria that predominate are bacillus and thermus. In some embodiments, the actinomycetes that predominate are streptomyces, micropolysporta, thermoactinomyces, and thermomonospora. In some embodiments, the fungi that predominate are aspergillus, mucor, chaetomium, humicola, absidia, sporotrichum, torula (yeast), and thermoascus.

In some embodiments, the method 100 can include inducing the second thermophilic stage by adding additional organic waste to the composting pile. In some embodiments, the method 100 can continue in step 103 including mixing the composting pile to initiate the composting process, wherein the composting pile then proceeds to the second thermophilic stage. In some embodiments, the method 100 then includes adding additional organic waste after step 105 to the composting pile, initiating the second thermophilic stage in step 106.

In some embodiments, the methods include transitioning the composting pile from the first thermophilic stage to the second thermophilic stage immediately and without any other transitionary stages. For example, in some embodiments, the methods do not include a mesophilic stage between the first and second thermophilic stages. In some embodiments, the transition from the first thermophilic stage to the second thermophilic stage includes shifting the temperature of the pile from about 65° C. to about 72° C. (e.g., first thermophilic stage) to about 55° C. to about 65° C. (e.g., second thermophilic stage). In some embodiments, the temperature shift between the first and second thermophilic stages is induced by adding additional organic waste.

The method 100 can continue in step 107 including a mesophilic stage. During the mesophilic stage, bacteria and fungi proliferate and assist in breaking down the organic matter into compost and, in particular, sugars, proteins, and starches. In some embodiments, during the mesophilic stage, the composting pile is maintained at a temperature of about 10° C. to about 55° C. For example, about 10° C., about 15° C., about 20° C., about 25° C., about 30° C., about 35° C., about 40° C., about 45° C., about 50° C., or about 55° C. In some embodiments, the mesophilic stage lasts for about 2 months to 6 months. For example, about 2 months, about 3 months, about 4 months, about 5 months, or about 6 months. In some embodiments, the composting pile is maintained at a temperature of about 10° C. to about 55° C. for about 2 months to 6 months.

In some embodiments, the composting pile is maintained at a temperature of about 10° C. to about 55° C. by monitoring and aerating (e.g., turning) the composting pile. To prevent the temperature of the composting pile from increasing beyond 55° C., the composting pile is turned and/or aerated, dissipating heat in the process. In some embodiments, the temperature of the composting pile is monitored throughout the mesophilic stage so as to ensure that the temperature range remains between about 10° C. to about 55° C. at least once, twice, or more times per week.

In some embodiments, during the mesophilic stage certain bacteria, fungi, and actinomycetes predominate. In some embodiments, the bacteria that predominate are bacillus, thermus, pseudomonas, flavobacterium, and clostridium. In some embodiments, the actinomycetes that predominate are streptomyces. In some embodiments, the fungi that predominate are Alternaria, Cladosporium, aspergillus, mucor, humicola, penicillium.

The method 100 can also include an optional curing stage, completing the composting process and obtaining the final composting material. The curing stage can include curing, aging, and maturing the composting material. During the curing stage, organic materials such as complex polymers continue to slowly break down, forming the final composting material. The available carbon in the compost becomes depleted, and microorganism populations decrease. As the microorganisms decrease, the production of greenhouse gases such as CO₂ also decreases. In some embodiments, the methods include determining whether the composting process is complete by measuring the CO₂ emissions from the composting pile. In some embodiments, the composting process is complete when the CO₂ emissions are between about 8,000 ppm to about 10,000 ppm. For example, the composting process is complete when the CO₂ emissions are about 8,000 ppm, about 8,500 ppm, about 9,000 ppm, about 9,500 ppm, or about 10,000 ppm. In some embodiments, the rate of CO₂ emissions is monitored at least about twice a week. Based on the continuous monitoring of the CO₂ emissions, a rate of CO₂ emissions can be determined. In some embodiments, the composting process is complete when the rate of the CO₂ emissions from the composting pile is between about 8% to about 10%, by weight, of the total weight of emissions from the composting pile. For example, the composting process is complete when the rate of CO₂ emissions is about 8%, about 8.5%, about 9%, about 9.5%, or about 10%.

The method 100 can also conclude at step 107 without the additional curing stage. After the mesophilic stage 107, the composting process can produce a finalized composting material, in which the entire composting process takes about 15 weeks to about 36 weeks. For example, the entire composting process can take about 15 weeks, about 16 weeks, about 17 weeks, about 18 weeks, about 19 weeks, about 20 weeks, about 21 weeks, about 22 weeks, about 23 weeks, about 24 weeks, about 25 weeks, about 26 weeks, about 27 weeks, about 28 weeks, about 29 weeks, about 30 weeks, about 31 weeks, about 32 weeks, about 33 weeks, about 34 weeks, about 35 weeks, or about 36 weeks.

In some embodiments, the method of forming composting material includes introducing water into the composting pile. In some embodiments, water is introduced into the composting pile during any one of steps 101-107 of the method 100. In some embodiments, water is added to the composting pile during the mixing step 103, where the composting pile is then turned to incorporate moisture throughout the composting pile. Turning the water into the composting pile not only conserves water but also ensures that moisture is dispersed throughout the composting pile.

In some embodiments, the method 100 can include repeating the steps 101-107 or any portion of the steps 101-107 to obtain multiple batches of composting material. In some embodiments, each batch obtained by repeating the steps or portions of the steps 101-107 are homogenous and possess similar properties (e.g., CEC and water retention). In some embodiments, the methods include repeating the steps or portions of the steps more than once, for example, 2, 3, 4, 5, 6, 7, 8, 9, or 10 times.

In some embodiments, after completion of steps 101-107 of method 100, a volume of the organic waste materials is reduced by at least about 30% as compared to a starting volume of the organic waste materials. For example, the volume of the organic waste materials is reduced by at least about 30%, at least about 35%, at least about 40%, at least about 45%, at least about 50%, at least about 55%, at least about 60%, at least about 65%, at least about 70%, at least about 75%, at least about 80%, at least about 85%, at least about 90% or more as compared to a starting volume of the organic waste materials. In some embodiments, after completion of steps 101-107 of method 100, a weight of the organic waste materials is reduced by at least about 30% as compared to a starting weight of the organic waste materials. For example, the weight of the organic waste materials is reduced by at least about 30%, at least about 35%, at least about 40%, at least about 45%, at least about 50%, at least about 55%, at least about 60%, at least about 65%, at least about 70%, at least about 75%, at least about 80%, at least about 85%, at least about 90% or more as compared to a starting weight of the organic waste materials.

In some embodiments, after completion of steps 101-107 of method 100, the composting pile maintains all or substantially all moisture through the composting pile as compared to the starting moisture content of the pile. In some embodiments, the composting pile maintains at least about 60% of the moisture content as compared to the starting moisture content of the pile. For example, the composting pile maintains at least about 65%, at least about 70%, at least about 75%, at least about 80%, at least about 85%, at least about 90%, at least about 95%, or at least about 100% of the moisture content as compared to the starting moisture content of the pile.

In some embodiments, the resulting composting material has less organic matter content as compared to the organic matter content of the starting organic waste material. In some embodiments, the composting material has less than about 5%, less than about 10%, less than about 15%, less than about 20%, less than about 25%, less than about 30%, or less than about 35%, by total dry weight, organic matter content as compared to the organic matter content of the starting waste material. In some embodiments, the starting organic waste material comprises 50%, by total dry weight, organic matter content and the final composting product comprises less than 40%, by total dry weight, organic matter content. In some embodiments, the starting organic waste material comprises 65%, by total dry weight, organic matter content and the final composting product comprises less than 40%, by total dry weight, organic matter content. In some embodiments, the starting organic waste material comprises 60%, by weight, organic matter content and the final composting product comprises less than 40%, by total dry weight, organic matter content. In some embodiments, the starting organic waste material comprises 85%, by total dry weight, organic matter content and the final composting product comprises less than 40%, by total dry weight, organic matter content.

In some embodiments, the resulting composting material comprises mycorrhizae (e.g., endomycorrhizae and/or ectomycorrhizae) that are produced during the composting process, which enhance the composting material (e.g., provide nutrients such as N).

In some embodiments, the method comprises (a) forming a composting pile comprising a first layer including woodchips and a second layer including an organic fertilizer, wherein the second layer is formed on top of the first layer; (b) adding organic waste material on top of the second layer to form a composting pile; (c) mixing the composting pile to initiate a composting process; (d) adding organic waste material to the composting pile; and (e) maturing the organic waste material to obtain a compost, wherein the maturing step includes (1) a first thermophilic stage lasting about 3 to about 4 weeks during which time the composting pile is maintained at a temperature of about 65° C. to about 72° C., (2) a second thermophilic stage lasting for about 1 to about 2 months during which the composting pile is maintained at a temperature of about 55° C. to about 65° C., and (3) a mesophilic stage wherein the composting pile is maintained at a temperature of about 10° C. to about 55° C. for a period of about 2 to about 6 months. In other embodiments, the steps or a portion of the steps are executed more than once, for example, 2, 3, 4, 5, or more times to obtain multiple batches of composting material.

### Examples

### Example 1: REYCOMP Composting Process

The following example describes the use of walnut husks as raw materials for generating compost and provides a methodology for producing compost (“REYCOMP Composting Process”) that results in composting material having superior qualities and characteristics as compared to composting material produced by traditional means.

### Methods—REYCOMP Process

### Preparation of the Composting Pile

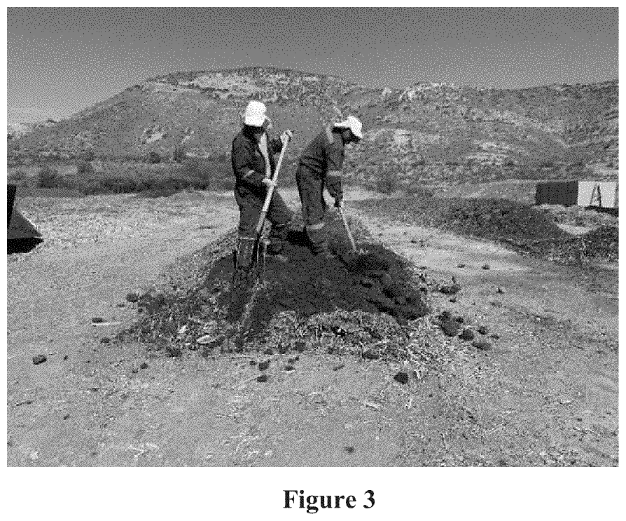

FIG. 3 shows an image depicting the process of forming a two-layer composting pile where a layer of guano is placed on top of a layer of woodchips. The process included forming a base of a composting pile with a layer of woodchips where the woodchip layer had a width of about 3.5 meters (11.48 ft) and a thickness of about 0.3 meters (0.98 ft). A layer of guano was then added on top of the bed of woodchips where the width of the guano layer had a width about 3.0 meters (9.84 ft) and a thickness of about 0.15 meters (0.49 ft). Once the two-layer pile (e.g., woodchips and manure) was prepared, waste from a walnut dehulling process was added on top of the pile, forming a composting pile referred to as a “windrow” pile.

### Composting Process

The composting process was then initiated with a first turning (e.g., aerating) of the composting pile via a windrow composting process where the pile, or windrow, was mechanically stirred to introduce oxygen (O₂) into the compost while simultaneously releasing waste gases (e.g., carbon dioxide (CO₂)) produced during bacterial decomposition of microbes in the guano.

The “active composting” process included two thermophilic stages, thermophilic stage I and thermophilic stage II (Table 1). The second thermophilic phase helped to ensure complete composting of the composting pile and thus prevented the additional step of screening and/or crushing large particles in the final compost product. Daily temperature records were taken throughout the active composting processes.

TABLE 1
Active Stages of the REYCOMP Composting Process

| Stage | Temperature Range | | Time | |
|---|---|---|---|---|
| Thermophilic I | 65°-72° C. | (149°-161° F.) | 3-4 | weeks |
| Thermophilic II | 55°-65° C. | (131°-149° F.) | 1-2 | months |
| Mesophilic | 10°-55° C. | (50°-131° F.) | 2-6 | months |

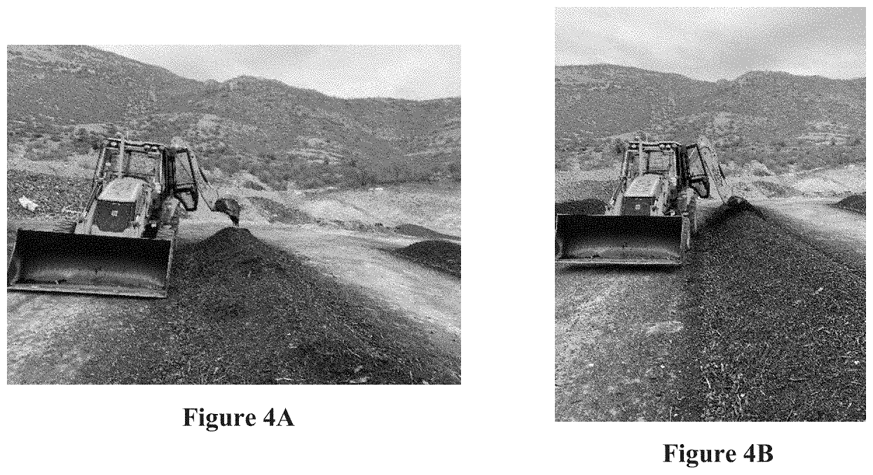

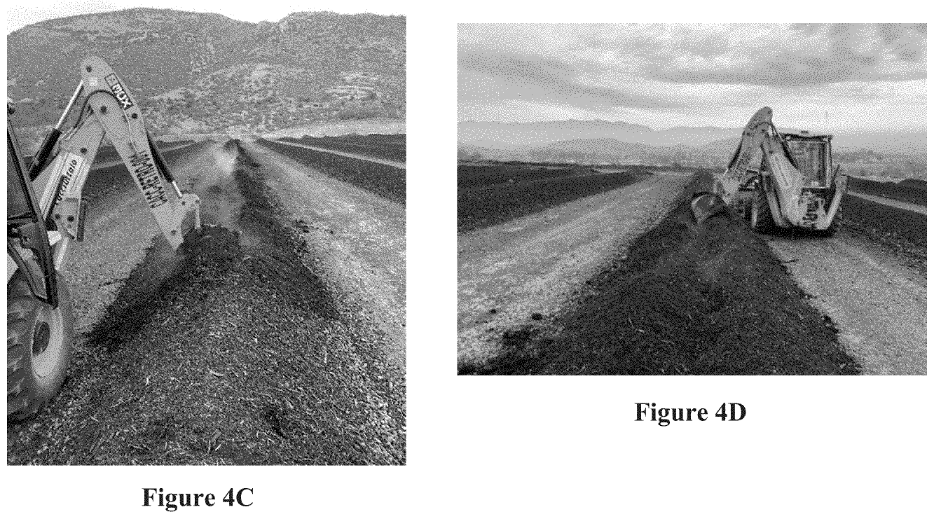

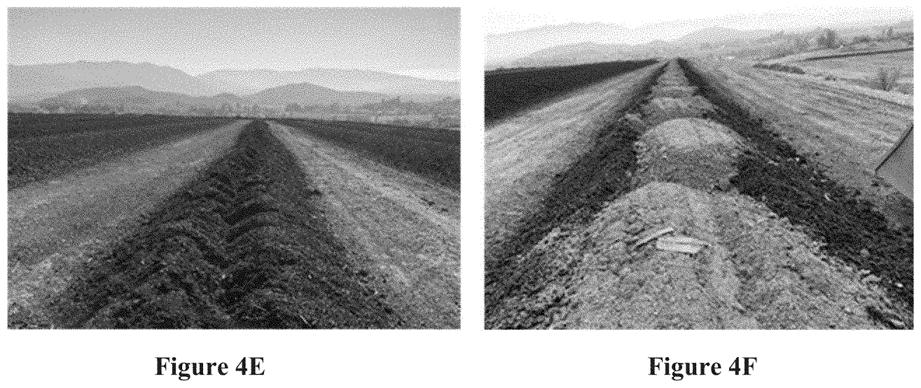

After a first turning of the pile, a second layer of waste from a walnut dehulling process was added to the pile during the active composting process (FIGS. 4A-4F). FIGS. 4A-4D show an improved method of incorporating additional waste material into the composting pile during the active composting process. The additional layer of waste was added to the pile by using a backhoe to rapidly open and/or create a hole in the pile during the active composting step (FIGS. 4A-4D). Once the pile was opened, the additional layer of waste was added to the pile (FIGS. 4E-4F). This process allowed for a fast and easy way to “open” or prepare the windrow for adding additional waste material. For example, for a windrow of 460 ft length, the process of opening the windrow and adding additional waste material takes only 5 to 10 minutes. This contrasts with other methods that require the use of compost turner equipment to add additional waste material. This is because compost turning equipment operates at a slow speed of 20 feet per min (ft/min) and is unable to cover the same ground over a short window of time as the REYCOMP Composting Process shown in FIGS. 4A-4F.

The process also included a mesophilic stage (Table 1). Once the maturation, or mesophilic, stage began, temperature records were taken two to three times a week. When the compost pile showed signs of maturation, measurements of the percentage of CO₂ in the piles were taken to observe the evolution of CO₂ release, which provided an indication of compost maturity. The pile is considered mature when it has not been turned for about two weeks and the rate of CO₂ emissions is less than 8%. One mature, the pile was declared “finished” and prepared for being sold.

### Results

The chemical composition of the final compost material obtained from the REYCOMP Composting Process is enumerated below in Table 2. Table 2 further provides a comparison of the final compost material to other, commercially available composting materials Class A and Class B (NCh 2880:2015).

TABLE 2
Chemical Composition of the Compost Generated from the REYCOMP
Composting Process and Comparative Composting Materials

| Element(s) | Units | REYCOMP | Class A | Class B |
|---|---|---|---|---|
| Ph | — | 9.7 | 5 | 8.5 |
| Electric | [dS/cm] | 9.3 | <3 | 8 |
| conductivity | | | | |
| (E.C) | | | | |
| Mat. Org | % | 43.8 | >20 | >20 |
| C Org. | % | 24.4 | >11 | >11 |
| N Total | % | 1.4 | >0.5 | >0.5 |
| C:N | | 18.2 | <30 | <30 |
| NH₄ | [mg/kg] | 461.0 | <500 | <500 |
| NO₃ | [mg/kg] | 362.0 | N/D | N/D |
| NH₄/NO₃ | | 1.3 | <3 | <3 |
| P₂O₅ | [%] | 1.8 | N/D | N/D |
| K₂O | [%] | 4.0 | N/D | N/D |
| CaO | [%] | 5.0 | N/D | N/D |
| MgO | [%] | 1.2 | N/D | N/D |
| C.E.C | [meq/ | 64.9 | N/D | N/D |
| | 100 g] | | | |
| Fe | [mg/kg] | 8932.7 | N/D | N/D |
| Mn | [mg/kg] | 424.2 | N/D | N/D |
| B | [mg/kg] | 110.4 | N/D | N/D |
| As | [mg/kg] | 0.7 | 15 | 33 |
| Cd | [mg/kg] | <0.01 | 0.7 | 9 |
| Cu | [mg/kg] | 83.8 | 70 | 400 |
| Cr | [mg/kg] | 11.9 | 70 | 100 |
| Hg | [mg/kg] | 0.6 | 0.4 | 2 |
| Ni | [mg/kg] | 8.2 | 25 | 80 |
| Pb | [mg/kg] | 6.2 | 45 | 220 |
| Zn | [mg/kg] | 100.8 | 200 | 800 |
| Humic Acid | [%] | 4.6 | N/D | N/D |
| Fulvic Acid | [%] | 3.2 | N/D | N/D |
| Total Humic | [%] | 7.7 | N/D | N/D |
| Extract | | | | |
| Moisture | [%] | 25.8 | 30 | 45 |
| Dry Matter | [%] | 74.2 | 70 | 55 |

The product obtained from the REYCOMP Composting Process has several differentiating characteristics as compared to the commercial composting materials on the market, and thus exhibits superior performance (Table 3). In particular, and as enumerated in Table 3 below, the resulting composting material has superior characteristics in terms of the organic matter, micronutrients, macronutrients, humic extracts, and microorganism content as compared to other commercially available composting materials such as NCh 2880:2015.

TABLE 3
Characteristics of Compost Generated from the REYCOMP
Composting Process and Comparative Composting Materials

| Components | REYCOMP | Others | NCh 2880:2015 |
|---|---|---|---|
| Organic Matter | ✓ | ✓ | ✓ |
| Micronutrients | ✓ | ¿? | x |
| Macronutrients | ✓ | ¿? | x |
| Humic Extracts | ✓ | ¿? | x |
| Microorganisms | ✓ | ¿? | x |

The commercially available composting materials Class A and Class B (NCh 2880:2015) are formed using traditional composting processes that differ from the REYCOMP Composting Process described above. The traditional methods include a composting process that comprises only one thermophilic stage with a temperature range (e.g., 50°-65° C.) that differs from the thermophilic stage I (e.g., 65°-72° C.) and the thermophilic stage II (e.g., 55°-65° C.) of the REYCOMP Composting Process (Table 4). In addition, the mesophilic stage of the traditional methods not only requires a different temperature range (e.g., 20°-50° C.) as compared to the REYCOMP Composting Process (e.g., 10°-55° C.), but also lasts significantly longer, taking up to 12 months. For comparison, the mesophilic stage of the REYCOMP Composting Process takes only between about 2 to 6 months. Further, the traditional methods do not include adding additional organic waste material to the composting pile during the active composting process.

Lastly, and without intending to be limited by any particular theory, it is contemplated that the superior characteristics (e.g., increased nutrients) of the compost derived from the REYCOMP Composting Process are also attributable to the high organic matter content of the starting waste material. When the organic waste has a low organic matter content, it is relatively easy to obtain composting materials having a near ideal amount of organic matter. The commercially available composting materials such as NCh 2880:2015 are formed from waste materials having a low organic material content (e.g., less than 23%). However, the REYCOMP Composting Process uses organic waste material having a high organic matter content (e.g., 50%), where the resulting compost product has a lower organic matter content (e.g., 40%). The reduction in organic matter content from the starting material to the final composting product can be attributed to mineralization of the organic matter into nutrients that are then available for plant growth. As a result, the final composting product has superior characteristics (e.g., increased nutrients) when formed from organic waste material having a high organic matter content as compared to organic waste material having a low organic matter content.

TABLE 4
Active Stages of Traditional Cornposting Process

| Stage | Temperature Range | | Time |
|---|---|---|---|
| Thermophilic | 50°-65° C. | (122°-149° F.) | 3-4 weeks |
| Mesophilic | 20°-50° C. | (68°-122° F.) | Up to 12 months |

### CONCLUSION

The following example details a process of manipulating raw materials (e.g., walnut waste) to form a quality composting material with characteristics such as high organic matter, micronutrients, macronutrients, humic extracts, and microorganisms that impart increased functionality to the compost as compared to traditionally produced compost. All or a portion of the steps of the REYCOMP Composting Process can be repeated to obtain multiple batches of composting material having a high degree of homogeneity—a rare accomplishment as large volumes of initial materials (e.g., organic waste) are required, introducing a high degree of variability. The REYCOMP Composting Process also optimizes available resources by retaining 100% of the water from the organic waste material. Water prevents the formation of leachate, and retention thus obviates an additional step of adding large amounts of water during the composting process. Lastly, while the REYCOMP Composting Process is not limited to the use of waste generated from walnut hulling, the use of walnut husks to generate composting material is particularly significant as walnut husks are generally considered toxic to other plants and their use in composting processes is limited. However, the REYCOMP Composting Process produces non-toxic organic fertilizer generated from walnut husks.

From the foregoing, it will be appreciated that specific embodiments of the invention have been described herein for purposes of illustration, but that various modifications may be made without deviating from the scope of the invention. Accordingly, the invention is not limited except as by the appended claims.

Various embodiments of the present technology are set forth herein below.

Para. A. A method of composting organic waste material, the method comprising: (a) forming a composting pile comprising a first layer including woodchips and a second layer including an organic fertilizer, wherein the second layer is formed on top of the first layer; (b) adding organic waste material on top of the second layer to form a composting pile; (c) mixing the composting pile to initiate a composting process; (d) adding organic waste material to the composting pile; and (e) maturing the organic waste material to obtain a compost, wherein the maturing step includes (1) a first thermophilic stage, (2) a second thermophilic stage, and (3) a mesophilic stage.

Para. B. The method of Para. A, wherein the first thermophilic stage lasts about 3 to about 4 weeks during which time the composting pile is maintained at a temperature of about 65° C. to about 72° C.

Para. C. The method of Para. A or B, wherein the second thermophilic stage lasts for about 1 to about 2 months during which the composting pile is maintained at a temperature of about 55° C. to about 65° C.

Para. D. The method of any one of Paras. A to C, wherein the mesophilic stage lasts for a period of about 2 to about 6 months during which the composting pile is maintained at a temperature of about 10° C. to about 55° C.

Para. E. A method of composting organic waste material, the method comprising: (a) forming a composting pile comprising a first layer including woodchips and a second layer including an organic fertilizer, wherein the second layer is formed on top of the first layer; (b) adding organic waste material on top of the second layer to form a composting pile; (c) mixing the composting pile to initiate a composting process; (d) adding organic waste material to the composting pile; and (e) maturing the organic waste material to obtain a compost, wherein the maturing step includes (1) a first thermophilic stage lasting about 3 to about 4 weeks during which time the composting pile is maintained at a temperature of about 65° C. to about 72° C., (2) a second thermophilic stage lasting for about 1 to about 2 months during which the composting pile is maintained at a temperature of about 55° C. to about 65° C. and (3) a mesophilic stage wherein the composting pile is maintained at a temperature of about 10° C. to about 55° C. for a period of about 2 to about 6 months.

Para. F. The method any one of Paras. A to E, wherein the steps are repeated to obtain multiple batches of compost.

Para. G. The method of any one of Paras. A to F, wherein the multiple batches of compost are homogenous.

Para. H. The method of any one of Paras. A to G, wherein a temperature of the composting pile is recorded daily during the first and second thermophilic stages.

Para. I. The method of any one of Paras. A to H, wherein a temperature of the composting pile is recorded once or twice a week during the mesophilic stage.

Para. J. The method of any one of Paras. A to I, wherein the composting pile retains at least about 80% of moisture from the organic waste material.

Para. K. The method of any one of Paras. A to J, wherein the first layer has a width of about 3.5 meters (m) and a height of about 0.3 m.

Para. L. The method of any one of Paras. A to K, wherein the second layer has a width of about 3 m and a height of about 0.15 m.

Para. M. The method of any one of Paras. A to L, wherein the organic waste material is obtained from waste generated from an industrial process.

Para. N. The method of Para. M, wherein the industrial process is an agro-industrial process.

Para. O. The method of Para. N, wherein the industrial process is nut hulling.

Para. P. The method of Para. O, wherein the nut hulling process is a walnut hulling process.

Para. Q. The method of any one of Paras. A to P, wherein the organic fertilizer is selected from the group consisting of animal matter, compost, animal excreta, human excreta, liquid manure, sea algae, lime, and vegetable matter.

Para. R. The method of any one of Paras. A to Q, wherein a volume of the organic waste material is about 50% to about 60% less than the starting volume of organic waste material.

Para. S. The method of any one of Paras. A to R, wherein a weight of the organic waste material is about 40% to about 70% less than a starting weight of the organic waste material.

Para. T. The method of any one of Paras. A to S, wherein the woodchips are obtained from shredding branches of a tree.

Para. U. The method of any one of Paras. A to T, wherein about 1,500 cubic meters to about 1,800 cubic meters of compost is produced from about 1 hectare.

Para. V. A composition comprising compost, wherein the composition comprises at least about 30%, by weight, organic matter of the total dry weight of the composition, wherein about 15% to about 30% of the organic material is carbon (C) and about 1% to about 2% of the organic material is nitrogen (N).

Para. W. The composition of Para. V, wherein the C to N ratio is about 18.2 to about 1.

Para. X. The composition of Para. V or W, wherein the N is present as ammonium (NH₄⁺) and nitrate (NO₃⁻), wherein the NH₄⁺ to NO₃⁻ ratio is about 1.3 to 1.

Para. Y. The composition of any one of Paras. V to X, further comprising about 1% to about 2%, by weight, phosphorus (P) of the total dry weight of the composition.

Para. Z. The composition of Para. Y, wherein the P is phosphorous pentoxide (P₂O₅).

Para. AA. The composition of any one of Paras. V to Z, further comprising about 2.5% to about 4.5%, by weight, potassium (K) of the total dry weight of the composition.

Para. AB. The composition of Para. AA, wherein the K is potassium oxide (K₂O).

Para. AC. The composition of any one of Paras. V to AB, further comprising about 3.5% to about 5.5%, by weight, calcium (Ca) of the total dry weight of the composition.

Para. AD. The composition of Para. AC, wherein the Ca is calcium oxide (CaO).

Para. AE. The composition of any one of Paras. V to AD, further comprising about 1% to about 2%, by weight, magnesium (Mg) of the total dry weight of the composition.

Para. AF. The composition of Para. AE, wherein the Mg is magnesium oxide (MgO).

Para. AG. The composition of any one of Paras. V to AF, wherein the compost has a cation exchange capacity (CEC) of about 65 Meq/100 g.

Para. AH. The composition of any one of Paras. V to AG, further comprising a micronutrient selected from the group consisting of zinc (Zn), iron (Fe), manganese (Mn), copper (Cu), and boron (B).

Para. AI. The composition of any one of Paras. V to AH, further comprising about 6% to about 10%, by weight, humic extract of the total dry weight of the composition.

Para. AJ. The composition of any one of Paras. V to AI, further comprising about 3% to about 5%, by weight, humic acid of the total dry weight of the composition.

Para. AK. The composition of any one of Paras. V to AJ, further comprising about 2% to about 4%, by weight, fulvic acid of the total dry weight of the composition.

Para. AL. The composition of any one of Paras. V to AK, wherein the composition has a moisture content of about 25%, by weight, of the total dry weight of the composition.

Para. AM. The composition of any one of Paras. V to AL, further comprising one or more microorganisms selected from the group consisting of mesophilic bacteria, filamentous fungi, yeast, actinomycetes, phosphate solubilizing microbes, trichoderma spp., bacillus spp., pseudomonas ssp., azotobacter ssp., amylolytic bacteria, cellulitis, proteolytic bacteria and mycorrhizae.

I/We claim:

1. A method of composting organic waste material, the method comprising:
(a) forming a composting pile comprising a first layer including woodchips and a second layer including an organic fertilizer, wherein the second layer is formed on top of the first layer;
(b) adding organic waste material on top of the second layer to form a composting pile;
(c) mixing the composting pile to initiate a composting process;
(d) adding organic waste material to the composting pile; and
(e) maturing the organic waste material to obtain a compost, wherein the maturing step includes (1) a first thermophilic stage lasting about 3 to about 4 weeks during which time the composting pile is maintained at a temperature of about 65° C. to about 72° C., (2) a second thermophilic stage lasting for about 1 to about 2 months during which the composting pile is maintained at a temperature of about 55° C. to about 65° C., and (3) a mesophilic stage wherein the composting pile is maintained at a temperature of about 10° C. to about 55° C. for a period of about 2 to about 6 months.

2. The method of claim 1, wherein the steps are repeated to obtain multiple batches of compost, wherein the multiple batches are homogenous.

3. The method of claim 2, wherein a temperature of the composting pile is recorded daily during the first and second thermophilic stages.

4. The method of claim 1, wherein a temperature of the composting pile is recorded once or twice a week during the mesophilic stage.

5. The method of claim 1, wherein the composting pile retains at least about 80% of moisture from the organic waste material.

6. The method of claim 1, wherein the first layer has a width of about 3.5 meters (m) and a height of about 0.3 m and the second layer has a width of about 3 m and a height of about 0.15 m.

7. The method of claim 1, wherein the organic waste material is obtained from waste generated from an industrial process.

8. The method of claim 7, wherein the industrial process is an agro-industrial process.

9. The method of claim 1, wherein the organic fertilizer is selected from the group consisting of animal matter, compost, animal excreta, human excreta, liquid manure, sea algae, lime, and vegetable matter.

10. The method of claim 1, wherein a volume of the organic waste material is about 50% to about 60% less than the starting volume of organic waste material.

11. The method of claim 1, wherein a weight of the organic waste material is about 40% to about 70% less than a starting weight of the organic waste material.

12. The method of claim 1, wherein about 1,500 cubic meters to about 1,800 cubic meters of compost is produced from about 1 hectare.

13. A composition comprising compost, wherein the composition comprises at least about 30%, by weight, organic material of the total dry weight of the composition, wherein about 15% to about 30% of the organic material is carbon (C) and about 1% to about 2% of the organic material is nitrogen (N).

14. The composition of claim 13, wherein the C to N ratio is about 18.2 to about 1.

15. The composition of claim 1, further comprising about 1% to about 2%, by weight, phosphorus (P) of the total dry weight of the composition; about 2.5% to about 4.5%, by weight, potassium (K) of the total dry weight of the composition; about 3.5% to about 5.5%, by weight, calcium (Ca) of the total dry weight of the composition; about 1% to about 2%, by weight, magnesium (Mg) of the total dry weight of the composition.

16. The composition of claim 1, wherein the compost has a cation exchange capacity (CEC) of about 65 Meq/100 g.

17. The composition claim 1, further comprising a micronutrient selected from the group consisting of zinc (Zn), iron (Fe), manganese (Mn), copper (Cu), and boron (B).

18. The composition of claim 1, further comprising about 6% to about 10%, by weight, humic extract of the total dry weight of the composition; about 3% to about 5%, by weight, humic acid of the total dry weight of the composition and about 2% to about 4%, by weight, fulvic acid of the total dry weight of the composition.

19. The composition of claim 1, wherein the composition has a moisture content of about 25%, by weight, of the total weight of the composition.

20. The composition of claim 1, further comprising one or more microorganisms selected from the group consisting of mesophilic bacteria, filamentous fungi, yeast, actinomycetes, phosphate solubilizing microbes, trichoderma spp., bacillus spp., pseudomonas ssp., azotobacter ssp., amylolytic bacteria, cellulitis, proteolytic bacteria, and mycorrhizae.
